(19) United States
(12) Patent Application Publication
(10) Pub. No.: US 2017/0372412 A1
(43) Pub. Date: Dec. 28, 2017

(54) Quantum-Annealing Computer Method for Selecting the Optimum Bids in a Combinatorial Auction

(71) Applicant: QC Ware Corp., Moffett Field, CA (US)

(72) Inventors: Matthew C. Johnson, Palo Alto, CA (US); Randall R. Correll, Mountain View, CA (US); Kay Giesecke, Woodside, CA (US); Peter L. McMahon, Menlo Park, CA (US)

(21) Appl. No.: 15/634,680

(22) Filed: Jun. 27, 2017

Related U.S. Application Data
(60) Provisional application No. 62/354,817, filed on Jun. 27, 2016.

(51) Int. Cl. G06Q 30/08; G06Q 30/02; G06Q 50/16

(52) U.S. Cl. CPC G06Q 30/08; G06Q 30/0283; G06Q 50/16

(57) ABSTRACT

An improved method uses quantum processing devices to determine optimal sets of bids in combinatorial auctions. In one approach, a list of bids is received. Each bid specifies a price for a package of one or more items offered in the auction. The bids may be conflicting. An objective function based on the list of bids is formulated. The objective function has a form suitable for solution by a quantum processing device, which is used to optimize the objective function, thereby determining which bids are accepted.

CROSS-REFERENCE TO RELATED APPLICATION(S)

This application claims priority under 35 U.S.C. §119(e) to U.S. Provisional Patent Application Ser. No. 62/354,817, “A quantum-annealing computer method for selecting the optimum bids in a combinatorial auction,” filed Jun. 27, 2016. The subject matter of all of the foregoing is incorporated herein by reference in its entirety.

BACKGROUND

### 1. Field of the Invention

This invention relates to the fields of quantum computing and combinatorial auctions.

### 2. Description of Related Art

Quantum processing devices exploit the laws of quantum mechanics in order to perform computations. Quantum processing devices commonly use so-called qubits, or quantum bits, rather than the bits used in classical computers. Classical bits always have a value of either 0 or 1. Roughly speaking, qubits have a non-zero probability of existing in a superposition, or linear combination, of 0 and 1. Certain operations using qubits and control systems for computing using qubits are further described in U.S. patent application Ser. No. 09/872,495, “Quantum Processing System and Method for a Superconducting Phase Qubit,” which is hereby incorporated by reference in its entirety.

Although people have been aware of the utility of quantum algorithms for many years, only in the past decade has quantum computing hardware begun to become available at practical scales. Therefore, there is a need for new and useful applications of quantum computing hardware.

### BRIEF DESCRIPTION OF THE DRAWINGS

Embodiments of the disclosure have other advantages and features which will be more readily apparent from the following detailed description and the appended claims, when taken in conjunction with the accompanying drawings, in which:

FIG. 1 is a diagram illustrating a combinatorial auction method implemented using a quantum processing device.

FIG. 2 is a logical diagram of one instance of a platform component of a QCaaS architecture and system, including certain related infrastructure components, described in accordance with one or more embodiments of the invention.

FIG. 3 is a logical diagram of some of the various software modules and components of the Server-Side Platform Library in FIG. 2, described in accordance with one or more embodiments of the invention.

FIG. 4 is a logical diagram of some of the various software modules and components of the Client-Side Platform Library in FIG. 2, described in accordance with one or more embodiments of the invention.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION OF THE PREFERRED EMBODIMENTS

Combinatorial auctions are often conducted where many items are up for sale and potential buyers can submit bids for one or more items as a package or subset of items, with one price bid for the entire subset. However, bids from different bidders might conflict in that they bid on the same item that cannot be sold to more than one bidder. The challenge for the auctioneer in this case is selecting the best set of bids from multiple bidders that brings in the highest revenue while avoiding any conflicting bids. Radio spectrum allocation auctions, estate auctions, as well as trucking, bus route, and industrial procurement auctions are examples of auctions that use this format.

When an auction has many items and many bidders—on the order of hundreds or more—deciding the most profitable set of non-conflicting bids to be accepted is mathematically difficult and complex, and can take more time—hours, days, or longer—than the auctioneer has to compute the optimal solution. This type of problem can be described mathematically as a discrete optimization problem, which can be difficult to solve.

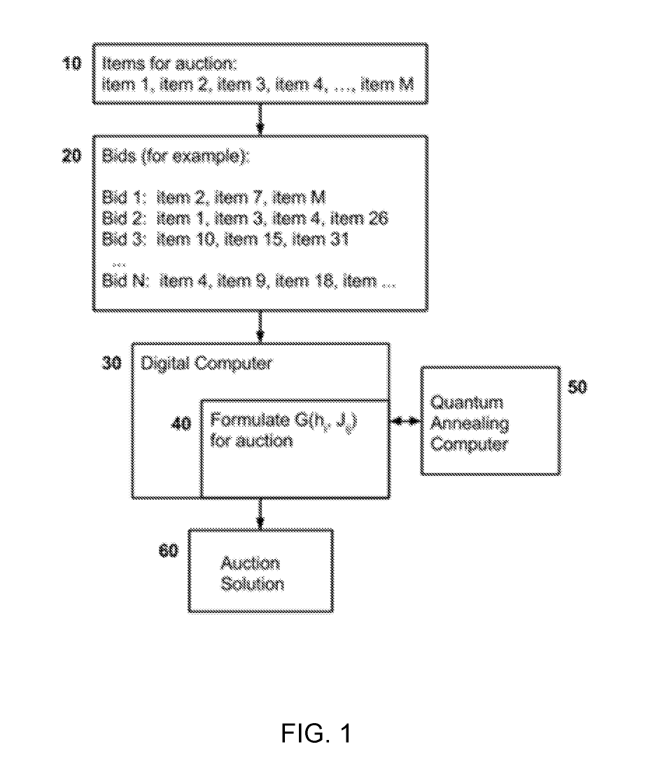

FIG. 1 is a diagram illustrating a method for resolving a combinatorial auction using a quantum processing device. This method formulates the problem and solves for the best solutions using the power of quantum annealing computers to achieve solutions much faster than existing methods running on traditional digital computer hardware alone.

Referring now to FIG. 1, block 10 is the list of items up for auction. This is typically provided by the auctioneer to inform the bidders of available items. Bidders can make offers for individual items or for packages of items.

Block 20 is the list of bids made by various bidders. Each bid includes a list of items to be purchased and the total price to be paid for the entire package of items. Each bidder submits their bids to the auctioneer, who assembles them into a list of bids. Each bid in the list details the items to be purchased and the price to be paid for all these items as a package.

Now the task is to select the best combination of bids that gives the auctioneer the highest revenue while excluding any conflicting bids. This is accomplished by using a traditional digital computer 30 to create 40 a bid selection objective function G that is optimized by a quantum annealing computer 50.

The bid selection formulation 40 begins by reading the bid list and constructing a mathematical function to be minimized that will represent the best solution. The method takes advantage of quantum annealing computers 50. Such computers solve problems that correspond to optimizing an objective function:

G=−Σᵢhᵢsᵢ−Σ_{i<j}Jᵢⱼsᵢsⱼ (1)

where i is the index for the different bids, and the hᵢ and Jᵢⱼ are arrays of coefficients to be determined 40 based on the list of items and list of bids. The sᵢ are a bit string of binary variables (1 or 0) where 1 indicates a particular bid i is in the final solution and 0 indicates the particular bid i is not in the final solution. If there are N bids submitted to the auctioneer, then sᵢ will have N number of ones or zeros. The objective function is optimized with respect to the sᵢ.

The task of the bid selection formulation 40 is to convert the bid list 20 into a mathematical formula of the type solved by the quantum annealing computer 50. The hᵢ are coefficients corresponding to the price paid for each bid. The Jᵢⱼ are used to penalize a pair of bids (bid i and bid j) that are conflicting bids—that is, that both have the same item included, so both bids cannot be selected. The Jᵢⱼ preferably are large enough that conflicting bids are avoided in the final solution. In one approach, the Jᵢⱼ are selected based on the maximum price hᵢ. Summing over this formula for a given bit string, sᵢ, representing a hypothetical selection of which bids are to be accepted and which to be rejected, will give a numerical value to the function G.

Once the G objective function has been determined 40, the digital computer 30 sends the G function via a network connection to the quantum annealing computer 50. The quantum annealing computer 50 rapidly solves for the bit string, sᵢ that most likely represents the best selection of bids for the auctioneer. The solution of which bids to accept is returned to the digital computer 30 and the final solution to the combinatorial auction is output 60 to the user. When an auction has many items and many bidders—on the order of several hundreds or more—deciding the most profitable set of non-conflicting bids is mathematically difficult and complex, and can take more time—hours or days—than the auctioneer has to compute the optimal solution. For conventional computers, the increase in solution time is exponential as the number of items and bids increases. Quantum annealing is able to provide a speedup for these large discrete optimization problems and reduce the time to solution to being solved in seconds, and preferably to less than a minute and more preferably to less than 10 seconds.

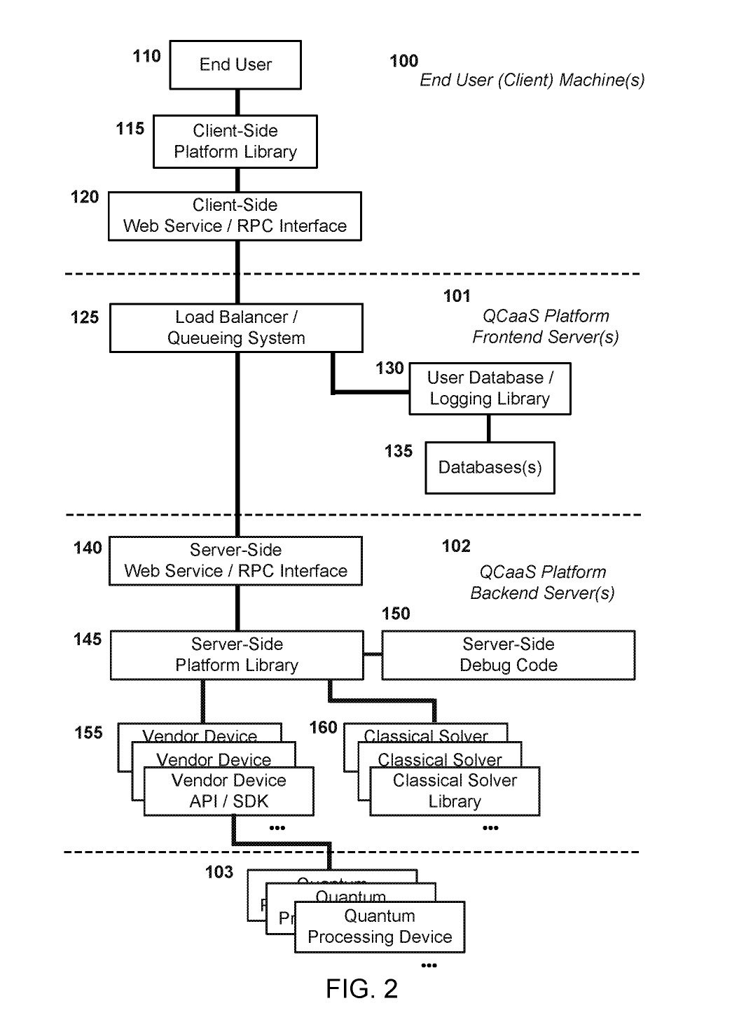

FIGS. 2-4 illustrate one implementation of quantum annealing computers that can be used to solve the combinatorial auction. In this example, the quantum annealing computer 50 is referred to as a quantum processing device 103.

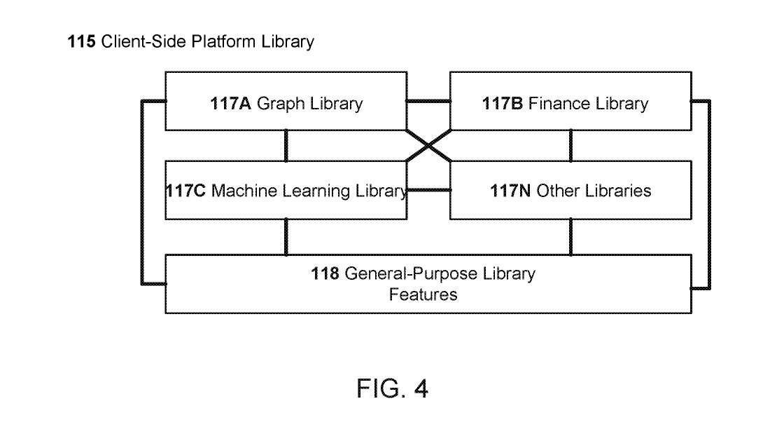

FIG. 2 is a logical diagram of one example of a platform component of a QCaaS (quantum computing as a service) architecture and system, including certain related infrastructure components, suitable for solving the combinatorial auction problem described above. In the diagram, dashed lines indicate boundaries where information passes between different machines and/or logical realms. In the diagram, an end user 110 working on a machine 100 interfaces with a client-side platform library 115 (explained in more detail in FIG. 4). This interaction may be, for example, the user inputting a problem in software code and calling a function in the client-side platform library 115 to pass that problem into the QCaaS system. The client-side platform library 115 then may communicate with a client-side web service or remote procedure call (RPC) interface 120 in order to transmit information about the problem to the remote QCaaS platform, for example in the form of user service requests.

The client-side platform library 115 may have any number of features to expose functionality for and ease the programming burden of the user. For instance, FIG. 4 shows several different modules that may be contained within the client-side library. This example includes a collection of general-purpose software routines, data structures, API endpoints, etc. in block 118. Additionally, the client-side library 115 may include any number of domain-specific libraries: collections of software routines, data structures, API endpoints, etc. that are designed specifically to aid with performing computations for specific domains. Examples include graph analytics 117A, finance 117B, machine learning 117C, or any other domains 117N. The additional libraries 117N need not be domain specific libraries but may be any such additional libraries or modules that add value and functionality to the client-side platform library 115. Preferably, the client-side platform library 115 is designed in such a way as to be extensible by any other such possible modules.

Once the information reaches the remote QCaaS frontend servers 101, the next step is to organize the user requests, for example by routing the information through a load balancer and/or queuing system 125. For instance, if many users are simultaneously using the QCaaS platform, and there are only limited computational resources available through the platform, some of the system preferable will schedule and order the processing of various users' submitted tasks in a reasonable manner. Any number of standard load balancing and queuing algorithms and policies may be used. For instance, one may use a standard round robin algorithm for load balancing.

When this information is passed to the QCaaS frontend servers 101, many potential tasks may be performed. For example, a frontend server 101 may authenticate the user 110 using a database 135 and library 130. The frontend server 101 may also log the information supplied by the user via a logging library 130 and store that information in a database 135. For instance, the frontend server might record copies of the problems that users submit to the platform.

When the load balancer/queuing system 125 deems that a problem is ready to run on the QCaaS system, the information is passed to one or more backend servers 102 in a format governed by a server-side web service/RPC interface 140. The backend servers 102 generally process the user problems to a form suitable for use with quantum processing devices.

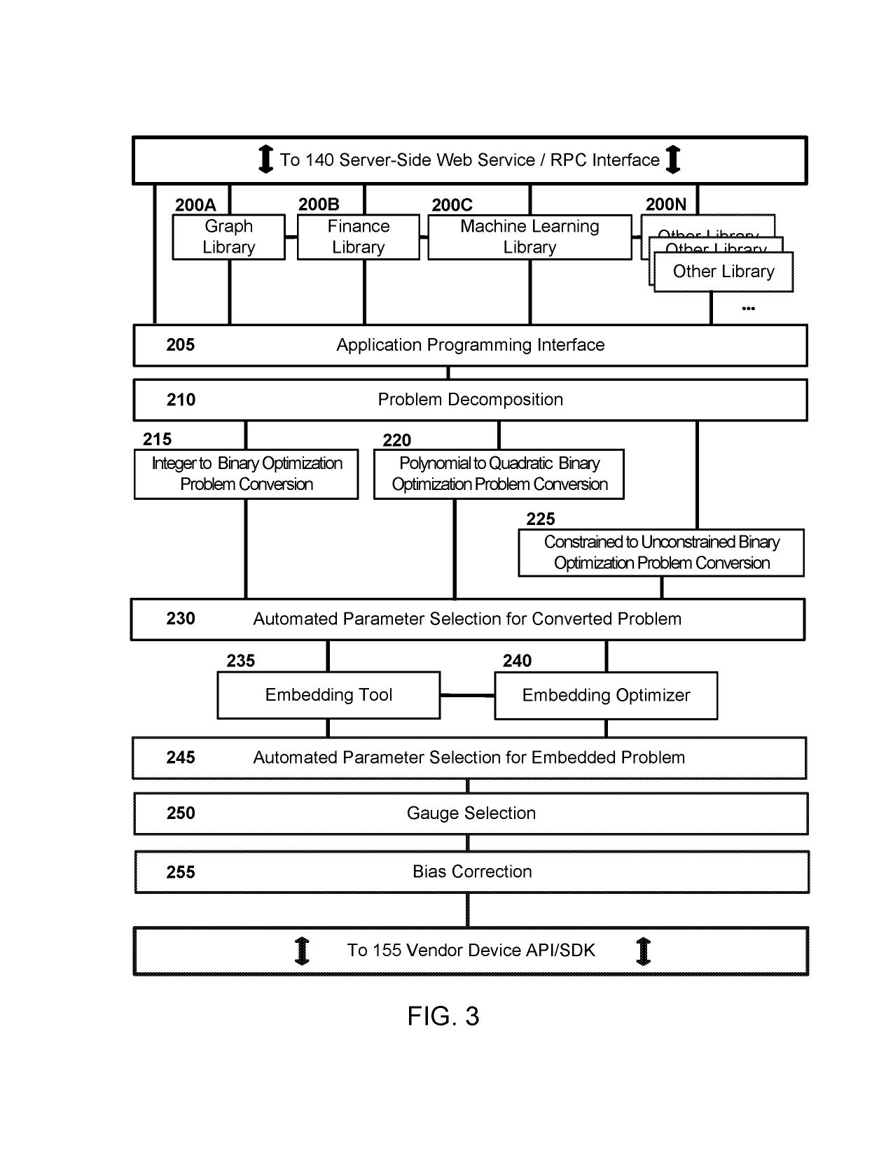

Passing through the backend interface 140, the problem information arrives at the server-side platform library 145 (explained in more detail in FIG. 3). The platform library 145 may interact with debugging libraries 150 or other similar libraries (e.g. logging libraries). The platform library 145 contains a variety of algorithms for taking a computational problem, preparing it for solution on quantum processing devices, executing the computational problem on such devices, and collecting and returning the results. The platform library 145 is not necessarily limited to interacting with just quantum processing devices. One or more classical solver libraries 160 for conventional processing devices may also be used by the platform library 145 for various purposes (e.g. to solve some part of a problem that is not well-suited to a quantum processing solution, or to compare an answer obtained on a quantum processing device to an answer obtainable via a classical solver library).

Generally, though not necessarily, the server-side platform library 145 processes a computational problem and any relevant information about it and passes that processed form onto one or more quantum computing interfaces, such as quantum processing device vendor APIs and/or SDKs 155. For example, if the end user 110 is solving a quadratic binary optimization problem, this problem may be converted by 145 into a form amenable for a D-Wave quantum processing device, whereupon the server-side platform library 145 passes the processed form of the problem to the low-level D-Wave API 155. Low-level APIs like these directly interact with the underling quantum processing devices 103. The quantum processing devices return one or more solutions, and possibly other related information, which are propagated back up the chain, to 155 and then to 145. Solutions and information, e.g. from 150, 155, and 160, are passed to and coalesced by 145. The resulting coalesced data returns to the user, for example via a reverse path through the server-side interface 140, load balancer 125, client-side interface 120, and client-side platform library 115, to finally arrive back at the end user 110.

The quantum processing devices 103 may be one or more physical devices that perform processing especially based upon quantum effects, one or more devices that act in such a way, one or more physical or virtual simulators that emulate such effects, or any other devices or simulators that may reasonably be interpreted as exhibiting quantum processing behavior.

Examples of quantum processing devices include, but are not limited to, the devices produced by D-Wave Systems Inc., such as the quantum processing devices (and devices built upon the architectures and methods) described in U.S. patent application Ser. No. 14/453,883, “Systems and Devices for Quantum Processor Architectures” and U.S. patent application Ser. No. 12/934,254, “Oubit [sic] Based Systems, Devices, and Methods for Analog Processing,” both of which are hereby incorporated by reference in their entirety. Other quantum processing devices are under development by various companies, such as Google and IBM.

Because quantum processing devices operate on qubits, the ability of qubits to exist in superpositions of 0 and 1 allows for greatly enhanced performance for certain computational tasks. For example, Shor's algorithm describes how a quantum processing device can be used to efficiently factor large integers, which has significant applications and implications for cryptography. Grover's search algorithm describes how a quantum processing device can be used to efficiently search a large set of information, such as a list or database. For further examples, see e.g. Shor, 1997, SIAM J. of Comput. 26, 1484; Grover, 1996, Proc. 28th STOC, 212 (ACM Press, N.Y.); and Kitaev, LANL preprint quant-ph/9511026, each of which is hereby incorporated by reference in their entireties.

FIG. 3 is a logical diagram of some of the various software modules and components of the Server-Side Platform Library 145 in FIG. 2, described in accordance with one or more embodiments of the invention. Data flows into and out of the platform library 145 via the interfaces 140,155 at the top and bottom of the diagram, corresponding to connections to other components in FIG. 2.

The platform library 145 may contain one or more domain-specific libraries 200 that may be useful for developing software for or solving problems on quantum processing devices. Each domain-specific library may include software routines, data models, and other such resources as may typically appear in a software library, just as in the case of the client-side platform library 115 shown in FIG. 3. FIG. 3 specifically shows graph analytics 200A, finance 200B, and machine learning 200C as domains where domain-specific libraries and routines may be especially useful, but library 200N emphasizes that any domain-specific library may be incorporated at this layer of the platform library. The numbering 200A-N emphasizes the extensible nature of the platform library. Based upon the components lower down in the diagram, any number of domain-specific libraries 200 may be written and integrated into the platform library 145.

The API 205 exposes the functions, data structures, models, and other core interfaces of the platform library 145. The API 205 may connect with one or more libraries 200A-N and/or may directly communicate with the server-side web service/RPC interface 140, depending on the information being supplied to the platform library 145. The API 205 is responsible for examining a problem and whatever information is supplied to the platform library 145 and determining how to execute the problem on quantum processing devices and/or classical solver libraries, with the help of the remaining modules shown in FIG. 3.

One such module is problem decomposition module 210. The processes conducted by this module involve taking a large problem and splitting it into smaller subproblems, whose solutions may be combined to obtain an exact or approximate solution to the entire problem. For example, if one is solving the Traveling Salesman Problem (TSP) for a large number of cities, there are heuristics in the literature for how to decompose the problem into multiple smaller TSP subproblems over smaller numbers of cities, and to then recombine the solutions of those subproblems into an approximate solution for the overall TSP problem.

An example of a canonical problem decomposition method that may be used in the platform is described in Benders, J. F. Numer. Math. (1962) 4: 238. doi:10.1007/BF01386316, which is incorporated by reference here in its entirety. In Benders' method, an optimization problem is split into an alternating sequence of linear and integer optimization problems that are each easier to solve than the overall optimization problem, which may be nonlinear, non-integer, etc. Benders' method offers certain bounds showing that a solution obtained via the decomposition method is within some approximation of the overall problem's optimal solution.

Another example of a problem decomposition method is the well-known Dantzig-Wolfe decomposition, explained for example on https://en.wikipedia.org/wiki/Dantzig%E2%80%93Wolfe_decomposition, which is incorporated by reference here in its entirety. In the Dantzig-Wolfe method, a linear programming problem of a certain structure is split into a set of subproblems involving distinct subsets of the problem variables. Optimal values of the subproblems are evaluated in the overall problem and are used as the next iterate in the algorithm if the value of the overall problem is improved.

Another potential problem decomposition approach is based on the “randomized search” idea used in, for example, U.S. patent application Ser. No. 13/332,721, which is incorporated by reference here in its entirety. Overall, problem decomposition is especially useful in the context of QCaaS since the currently commercially available quantum processing devices have significantly limited memory. Hence, many problems of practical size must be decomposed in order to fit into the memories of the available quantum processing devices.

The modules, 215, 220, and 225, relate to taking a discrete optimization problem of one form and converting it into a quadratic binary unconstrained form. While certainly not all problems solved on quantum processing devices are discrete optimization problems, the relatively popular D-Wave quantum processing devices have been found to be especially well-suited for this class of problems. Hence, the platform library 145 includes these special modules 215, 220, and 225.

Module 215 uses heuristics to convert an integer optimization problem into a binary optimization problem. One such heuristic operates when the integer formulation of the optimization problem is over a finite set of choices. For instance, if a variable in an integer optimization problem may take on the values 2, 3, or 4, then this may be recast as three binary variables corresponding to (a) whether or not the value is 2, (b) whether or not the value is 3, and (c) whether or not the value is 4, along with some mutual exclusivity constraints between the three binary variables (e.g., the sum of the three binary variables must equal one). While this is a standard heuristic used for integer to binary optimization problem conversion, other heuristics and algorithms may be implemented by module 215 as appropriate.

Module 220 uses heuristics to convert a higher-order polynomial binary optimization problem into a quadratic binary optimization problem. In one embodiment, module 220 use a third-party software library to provide such functionality (indeed, this is generally true of all components of the platform). For instance, module 220 may use the “reduce_degree” utility in the D-Wave low-level API. Another approach is based on adding penalty terms to ensure that ancillas get the correct values (if penalty terms are too small, ancillas may easily obtain the wrong values). Such an approach is documented in arXiv:0801.3625v2[quant-ph], which is incorporated by reference here in its entirety.

Module 225 uses heuristics involving penalty terms to convert a constrained binary optimization problem into an unconstrained binary optimization problem. One implementation of this module is documented in Pierre Hansen, “Methods of Nonlinear 0-1 Programming,” Annals of Discrete Mathematics, Elsevier, 1979, which is incorporated by reference here in its entirety. Other mathematical techniques for constrained to unconstrained conversion for binary optimization problems will be apparent.

Depending on the input provided to the platform library 145, none, one, some, or all of these modules 215, 220, 225 may be used in order to prepare the problem for solution on the quantum processing devices and/or other solver libraries underlying the platform. Other such modules are certainly possible and may also be used within the platform. For instance, one such module converts formulations of problems that can be run on quantum annealing processing devices (such as the quantum processing devices developed by D-Wave) to formulations that can be run on gate-model quantum processing devices. Such a module may work via “Trotterization,” see e.g. arXiv:1611.00204v2[quant-ph] (which is incorporated by reference here in its entirety). Another such possible module would convert gate-model formulations of certain problems into formulations amenable to solution on quantum annealing processing devices. Other additional relevant modules may be included at this layer of the platform. The above list is not exhaustive.

Module 230 provides optimizations for the processed problem in order to improve the quality of the solution obtained via the platform. The operations performed are documented in arXiv:1503.01083v1[quant-ph], which is incorporated by reference here in its entirety. Roughly speaking, we first obtain the strict embedding (the percentage of chains whose qubits all take the same value) for different values of intracoupling strength J_{E}. We then fit this data with a Sigma curve. Next, we use the Sigma curve to determine the point at which the strict embedding is 0.5. Then, for a defined range of values centered at 0.5, we calculate the πₑₗᵢₜₑ value (the best percentage of the obtained logic energies). Finally, we use the J_{E} value that results in the best πₑₗᵢₜₑ.

When the problem is in an optimized state, embedding tools 235, 240 may be run to fit the problem onto a model of the particular hardware architecture of a target quantum processing device. For instance, if a problem is to be solved using a D-Wave quantum processing device, these tools will map the problem onto the chimera graph architecture of that device. The embedding tool 235 may be vendor-supplied or a third-party library, whereas tool 240 can take the output of another embedding tool 235 and provide additional optimizations to make the embedding as compact as possible.

Tool 240 may function by comparing an input problem to similar problems input in the past, and using the good embeddings found for those prior problems as starting points for computing good embeddings for the current input problem. Alternatively, 240 may operate by running the embedding tool 235 multiple times, and choosing the best result to use as the embedding (such may be the mode of operation when tool 235 produces different outputs for different executions). The “best” output of tool 235 may be the embedding with the fewest number of qubits used, the embedding with the shortest chain lengths, or some other criteria that may be specified. Other techniques may be incorporated into the platform for selecting and optimizing embeddings.

The embedded problem (output of tools 235 and/or 240) is then optimized for execution on a specific device via modules 245, 250, 255. One such process is essentially the same process as performed by embedding tool 230. Additionally, for example, with a D-Wave quantum processing device, there are a number of gauges that can be tuned via the low-level D-Wave API, and biases in couplers and local fields (which distort results) may exist in the device. The gauge selection module 250 is based on the techniques in arXiv:1503.01083v1[quant-ph], which is incorporated by reference here in its entirety.

The idea of this gauge selection method is to study the gauge space. We set a number of gauges that we apply to our embedded problem, and we solve that problem for a given number of runs. Then, using different parameters, such as the πₑₗᵢₜₑ value, we choose the elite gauges based on their scores. Usually these are several gauges that we run more in depth, assuming that they will return better solutions. This metric is usually quite noisy, and thus the choice of several gauges. For bias correction, the platform may use, for example, the D-Wave-provided automatic bias correction feature. Other bias correction strategies are known in the literature, and such strategies may be incorporated into the platform as appropriate as various quantum processing devices become available and mature. Overall, these modules ensure the optimal device-level parameters are automatically selected, obviating the need for the end user 110 to possess deep architecture- and device-specific knowledge in order to obtain high-quality solutions.

Note that the collection of modules in the server-side platform library may be executed iteratively or in the style of a “feedback loop,” where one or more of the modules are executed repeatedly, either in parallel or in serial. For example, one may wish to re-execute both the embedding routines 235 and then the automated parameter selection 245 in order to obtain a better embedding and better parameters for the embedded problem. Generally, many of the modules, e.g. 230, 235, 240, 245, 250, 255, etc., may benefit from multiple executions, and as such, the platform may include options and modes for executing some or all of the modules repeatedly in the style of a feedback loop in order to obtain more suitable results. The platform does not restrict which modules may be run in this iterative fashion.

At the very end of the process, the optimized problem is dispatched to one or more vendor device APIs/SDKs 155. At a later point in time, solutions are returned and are passed back to the end user, as described above and as shown in FIG. 2.

While not shown in FIG. 3, classical solver libraries 165 may be interfaced with FIG. 3 via connections to, for example, one or more of modules 205, 210, 215, 220, and 225. Depending on the classical solver library, other connections may also be possible or appropriate.

Combinatorial auctions may be implemented on the QCaaS platform shown in FIGS. 2-4 as follows. The client-side platform library 115 includes a library for combinatorial auction or even several libraries for different types of combinatorial auctions. Blocks 10, 20 and 60 of FIG. 1 are implemented as part of the client-side platform library 115. Block 40 of FIG. 1 can be split between the client-side platform library 115 and the corresponding server-side platform library 145, for example modules 200 and 225 of FIG. 3. Module 210 of FIG. 3 may also be relevant, for example if the problem as a whole is too large to be solved by a single quantum processing device.

Although the detailed description contains many specifics, these should not be construed as limiting the scope of the invention but merely as illustrating different examples and aspects of the invention. It should be appreciated that the scope of the invention includes other embodiments not discussed in detail above. Various other modifications, changes and variations which will be apparent to those skilled in the art may be made in the arrangement, operation and details of the method and apparatus of the present invention disclosed herein without departing from the spirit and scope of the invention as defined in the appended claims. Therefore, the scope of the invention should be determined by the appended claims and their legal equivalents.

The term “module” is not meant to be limited to a specific physical form. Depending on the specific application, modules can be implemented as hardware, firmware, software, and/or combinations of these. Furthermore, different modules can share common components or even be implemented by the same components. There may or may not be a clear boundary between different modules, even if drawn as separate elements in the figures.

What is claimed is:

1. A method for resolving a combinatorial auction, comprising:
receiving a list of bids, each bid specifying a price for a package of one or more items offered in the auction, wherein the bids may be conflicting;
formulating an objective function based on the list of bids, the objective function having a form suitable for solution by a quantum processing device; and
using a quantum processing device to optimize the objective function, thereby determining which bids are accepted.

2. The method of claim 1 wherein the objective function includes a term that maximizes total price received for accepted bids.

3. The method of claim 1 wherein the objective function includes a term that avoids acceptance of conflicting bids.

4. The method of claim 1 wherein the objective function has a form
G=−Σᵢhᵢsᵢ−Σ_{i<j}Jᵢⱼsᵢsⱼ
where i is an index for the bids, hᵢ are coefficients based on the price for bid i, Jᵢⱼ are coefficients based on whether bids i and j are conflicting, and sᵢ are binary variables that indicate whether bid i is accepted.

5. The method of claim 4 wherein hᵢ is the price for bid i, and the Jᵢⱼ are selected based on a largest of the prices hᵢ.

6. The method of claim 5 wherein all Jᵢⱼ have a magnitude that is larger than the largest of the prices hᵢ.

7. The method of claim 1 wherein the method is performed repeatedly as more bids are received.

8. The method of claim 1 wherein the combinatorial auction is one of an estate auction, a trucking auction, a bus route auction, and an industrial procurement auction.

9. The method of claim 1 wherein the quantum processing device optimizes the objective function in less than one minute.

10. The method of claim 1 wherein receiving the list of bids and formulating the objective function are performed by a conventional processing device, the conventional processing device further configuring the quantum processing device to optimize the formulated objective function.

11. A computer system for resolving a combinatorial auction, comprising:
a digital computer that executes software to:
receive a list of bids, each bid specifying a price for a package of one or more items offered in the auction, wherein the bids may be conflicting; and
formulates an objective function based on the list of bids, the objective function having a form suitable for solution by a quantum processing device; and
a quantum processing device coupled to the digital computer, the digital computer configuring the quantum processing device to optimize the objective function,
thereby determining which bids are accepted.

12. The computer system of claim 11 wherein the objective function includes a term that maximizes total price received for accepted bids.

13. The computer system of claim 11 wherein the objective function includes a term that avoids acceptance of conflicting bids.

14. The computer system of claim 11 wherein the objective function has a form
G=−Σᵢhᵢsᵢ−Σ_{i<j}Jᵢⱼsᵢsⱼ
where i is an index for the bids, hᵢ are coefficients based on the price for bid i, Jᵢⱼ are coefficients based on whether bids i and j are conflicting, and sᵢ are binary variables that indicate whether bid i is accepted.

15. The computer system of claim 14 wherein hᵢ is the price for bid i, and the Jᵢⱼ are selected based on a largest of the prices hᵢ.

16. A platform for providing quantum computing as a service, the platform comprising:
a client side interface;
a frontend server that receives user service requests from a plurality of users via the client side interface, the user service requests to be performed on quantum processing devices not dedicated to or directly accessible by any of the users, the frontend server organizing the user service requests;
a server side interface;
a backend server that receives the user service requests from the frontend server via the server side interface, the backend server processing the user service requests to a form suitable for quantum processing devices; and
a quantum computing interface, the backend server transmitting the user service requests to the quantum processing devices via the quantum computing interface;
wherein the user service requests include requests for resolving a combinatorial auction, the backend server including a server side combinatorial auction library that processes the user service requests for resolving a combinatorial auction to a form suitable for the quantum processing devices.

17. The platform of claim 16 wherein:
the user service requests from the frontend server include a list of bids, each bid specifying a price for a package of one or more items offered in the auction, wherein the bids may be conflicting; and
the server side combinatorial auction library formulates an objective function based on the list of bids, the objective function having a form suitable for solution by the quantum processing devices; and
transmitting the user service requests to the quantum processing devices comprises configuring the quantum processing devices to optimize the objective function, thereby determining which bids are accepted.

18. The platform of claim 16 wherein the frontend server includes a client-side combinatorial auction library.

19. The platform of claim 16 wherein the backend server comprises a plurality of different server side platform libraries, the plurality of different server side platform libraries including the server side combinatorial auction library.

20. The platform of claim 16 wherein the backend server comprises a plurality of server side combinatorial auction libraries for different types of combinatorial auctions.
